(19) United States
(12) Patent Application Publication
(10) Pub. No.: US 2009/0323246 A1
(43) Pub. Date: Dec. 31, 2009

(54) METHOD, DEVICE, INJECTOR AND CONTROL UNIT FOR TRIGGERING AN INJECTOR

(76) Inventors: Ulrich BRENNER, Moeglingen (DE); Georg KURZ, Schwieberdingen (DE); Martin KESSLER, Schwaebisch Gmuend (DE); Bertram SUGG, Gerlingen (DE)

Correspondence Address: KENYON & KENYON LLP, ONE BROADWAY, NEW YORK, NY, 10004, US

(21) Appl. No.: 12/469,190

(22) Filed: May 20, 2009

(30) Foreign Application Priority Data
Jun. 27, 2008 (DE) 102008002737.5
Oct. 29, 2008 (DE) 102008043259.8

(51) Int. Cl. H01H 47/00

(52) U.S. Cl. 361/154

(57) ABSTRACT

A method and a device for triggering an injector are described, allowing expansion of the metering range of the injector. The injector is triggered by a trigger voltage that is adjusted according to a predefined voltage for opening the injector, the trigger voltage being first increased to open the injector, starting from the predefined voltage, and then reduced after a predefined time. The predefined time is selected in such a way that the energy stored in an energy accumulator mechanism of the injector has reached a steady-state energy level after the predefined time.

### CROSS REFERENCE

The present application claims benefit under 35 U.S.C. §119 of German Patent Application No. 102008002737.5 filed on Jun. 27, 2008, and German Patent Application No. 102008043259.8 filed on Oct. 29, 2008, both of which are expressly incorporated herein by reference in their entireties.

### FIELD OF THE INVENTION

The present invention is directed to a method, a device for triggering an injector, an injector, and a control unit.

### BACKGROUND INFORMATION

German Patent Application No. DE 198 33 830 A1 describes that at the start of triggering, a solenoid valve is acted upon by an elevated booster voltage in comparison with the further triggering.

### SUMMARY

A method, device, injector and control unit according to example embodiments of the present invention, may have the advantage that the injector is triggered by a trigger voltage, which is set according to a predefined voltage for opening the injector, the trigger voltage for opening the injector initially being increased, starting from the predefined voltage, and then reduced again after a predefined period of time, the predefined period of time being selected in such a way that the energy stored in an energy accumulator mechanism of the injector will have reached a steady-state energy level after the predefined period of time. In this way, linearization of the relationship between the trigger time, during which the injector is acted upon by the trigger voltage, and the fuel quantity injected during the trigger time is achieved specifically for shorter trigger times. This allows expansion of the metering range, i.e., the spread between a maximum fuel injection quantity at full load and a minimum injection quantity in idling of an internal combustion engine, in which the relationship between the trigger time of the injector and the fuel quantity injected during the trigger time is linear. This is important for supercharged internal combustion engines in particular, because the spread between the maximum fuel injection quantity at full load and the minimum fuel injection quantity in idling increases with the degree of supercharging.

The example embodiments of the present invention may thus allow expansion of the metering range inexpensively.

It may be advantageous if the predefined voltage is adjusted as a function of an instantaneous power supply voltage. The predefined voltage is implementable in a particularly simple manner in this way, in particular when it is selected to be the same as the instantaneous power supply voltage.

Another advantage may be obtained when a capacitor is charged during the unenergized phases of the injector and its voltage is switched in series with the predefined voltage for opening of the injector when the injector is activated. An especially simple and cost-optimized temporary increase in voltage is made possible for the trigger voltage in this way.

It may be advantageous if the capacitor is charged to approximately the predefined voltage during the unenergized phases of the injector. The desired increase in voltage of the trigger voltage is implementable in a particularly safe and reliable manner in this way.

It is also advantageous if the trigger voltage is increased starting from the predefined voltage by an upconverter, preferably by pulse-width modulation. An increase in the trigger voltage of the injector, which is independent of the charge status of a capacitor, is reliably ensured in this way.

Similarly, the increase in trigger voltage, starting from the predefined voltage, may be reduced safely and reliably by a downconverter after the predefined period of time has elapsed, preferably by pulse-width modulation or a series-connected resistor.

It may also be advantageous if the predefined time is selected in such a way that it is within a predefined tolerance range with respect to achieving the steady-state energy level, the predefined tolerance range defining at most the limits within which the energy level achieved remains constant even after reducing the trigger voltage to the predefined voltage. This ensures that an expansion of the linear relationship between trigger time and fuel quantity injected during the trigger time is achievable by increasing the trigger voltage.

### BRIEF DESCRIPTION OF THE DRAWINGS

Exemplary embodiments of the present invention are illustrated in the figures and explained in greater detail below.

FIG. 1 shows an example device according to the present invention for triggering an injector according to a first specific embodiment.

FIG. 2 shows a flow chart for an exemplary sequence of an example method according to the present invention.

FIG. 3a shows a curve of a trigger voltage of the injector over time.

FIG. 3b shows a curve of the lift of the example injector over time.

FIG. 3c shows a curve of the energy of an energy accumulator mechanism of the example injector over time.

FIG. 4 shows an example device according to the present invention for triggering an injector according to a second specific embodiment.

### DETAILED DESCRIPTION OF EXAMPLE EMBODIMENTS

In intake manifold injection in gasoline engines, injected fuel quantity q_{dyn} is controlled via trigger time tᵢ of the injector. The goal is the largest possible range having a linear relationship between trigger time tᵢ and fuel quantity q_{dyn} injected via the injector during trigger time tᵢ. The smaller the minimum representable injected fuel quantity that still conforms to this linear relationship, the greater is the metering range of the injector.

In addition, the operation of the injection system must be ensured even when there is a minimum voltage U_{Bmin} of the vehicle electrical system. In configuring the magnetic circuit of an injector designed as a solenoid valve, this results in a compromise between the minimum force required for opening the injector at minimum voltage U_{Bmin} of the vehicle electrical system and the linearity of the relationship between tᵢ and q_{dyn}. In the case of regular or nominal voltage U_{Bnom}>U_{Bmin} of the vehicle electrical system, the magnetic circuit configured for minimum voltage U_{Bmin} of the vehicle electrical system is operated far into the nonlinear saturation range, at least partially and in particular for shorter trigger times tᵢ.

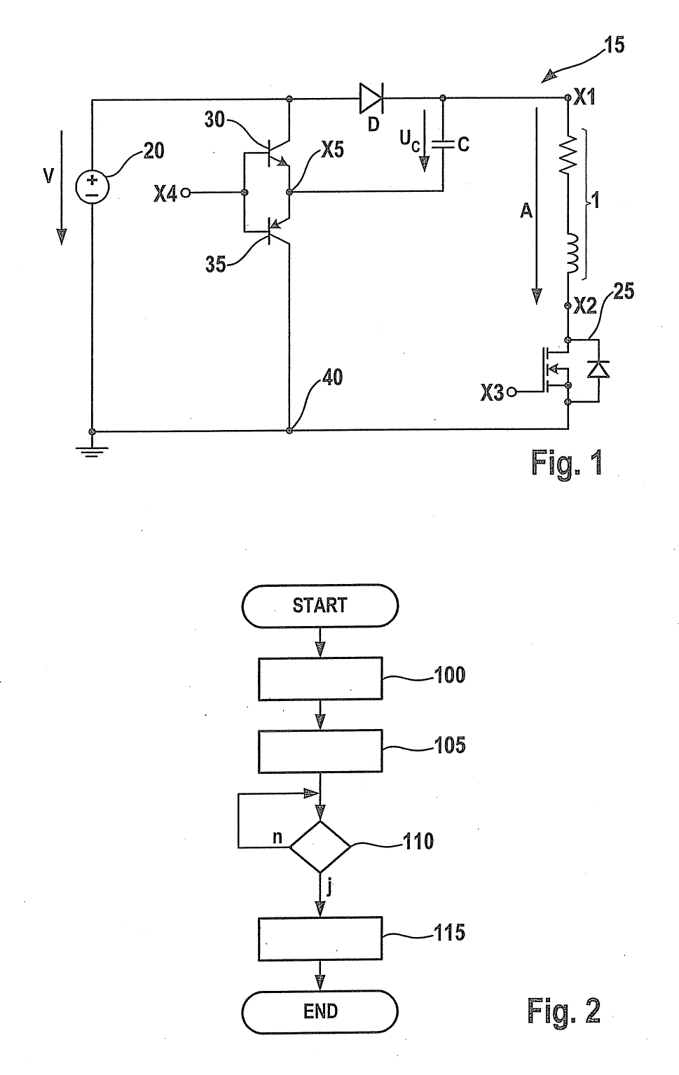

FIG. 1 shows as an example a circuit device 15 for triggering an injector 1 designed as a solenoid valve having a trigger voltage A according to a first specific embodiment. Circuit device 15 may be situated in a control unit, for example. The magnet coil of the injector, labeled as 1 in FIG. 1, is connected via a diode D to a battery 20, which forms vehicle electrical system voltage U_{B}, corresponding in this exemplary embodiment to a predefined voltage V forming trigger voltage A. On the other hand, battery 20 is connected to a reference potential 40, e.g., to ground. The connection of magnet coil 1 to diode D is labeled as X1 in FIG. 1 and represents a first terminal of magnet coil 1. A second terminal X2 of magnet coil 1 is connectable via first controlled or controllable switch 25 to reference potential 40. The magnet coil and therefore the injector in the first specific embodiment shown in FIG. 1 are thus connected to the control unit or circuit device 15 via terminals X1, X2. Furthermore, diode D is situated in the circuit according to FIG. 1, in such a way that its cathode is connected to first terminal X1 and its anode is connected to battery 20. First controllable switch 25 has a control terminal X3. First controllable switch 25 may be designed as an electronic switch, for example, in the form of a field-effect transistor FET, e.g., in the form of a MOS-FET or as a bipolar transistor. The anode of diode D is connectable to reference potential 40 via a second controlled switch 30 and a third controlled switch 35. Second controlled switch 30 and third controlled switch 35 may each also be designed as a field-effect transistor or as a bipolar transistor. In the present example, first controlled switch 25 is designed as an n-channel MOS field-effect transistor, while second controlled switch 30 is designed as an npn-bipolar transistor and third controlled switch 35 is designed as a pnp-bipolar transistor. A shared control input of second controlled switch 30 and third controlled switch 35 is labeled as X4 in FIG. 1. The emitter of second controlled switch 30 is connected to the emitter of third controlled switch 35 via a potential X5. A capacitor C is provided between the cathode of diode D and potential X5 between two switches 30, 35. The voltage drop from the cathode of diode D to potential X5 is labeled as capacitor voltage U_{C} in FIG. 1.

During unenergized phases of magnet coil 1, i.e., when first controlled switch 25 is opened, capacitor C is charged via diode D approximately to predefined voltage V and thus the instantaneous power supply voltage of battery 20. In this case, second controlled switch 30 is nonconducting and third controlled switch 35 is conducting, i.e., second controlled switch 30 is opened and third controlled switch 35 is closed. To this end, first controlled switch 25 is triggered on its control terminal X3 and second controlled switch 30 and third controlled switch 35 are triggered similarly via their shared control terminal X4. If the magnet coil at 1 is energized by a suitable control signal at its control input X3 by switching on first controlled switch 25, then at the same time by similarly triggering shared control input X4, second controlled switch 30 is closed and third controlled switch 35 is opened. Therefore, charged capacitor C is acting in series with predefined voltage V, causing a temporary increase in trigger voltage A from value V to value V+U_{C}. After a predefined time T has elapsed, this increase is reversed again by reopening second controlled switch 30 and simultaneous closing of third controlled switch 35 via a suitable triggering signal at shared control terminal X4, so that after predefined time T has elapsed, trigger voltage A drops back to the level of predefined voltage V. At the same time, after predefined time T has elapsed, capacitor C is charged again approximately to predefined voltage V via diode D.

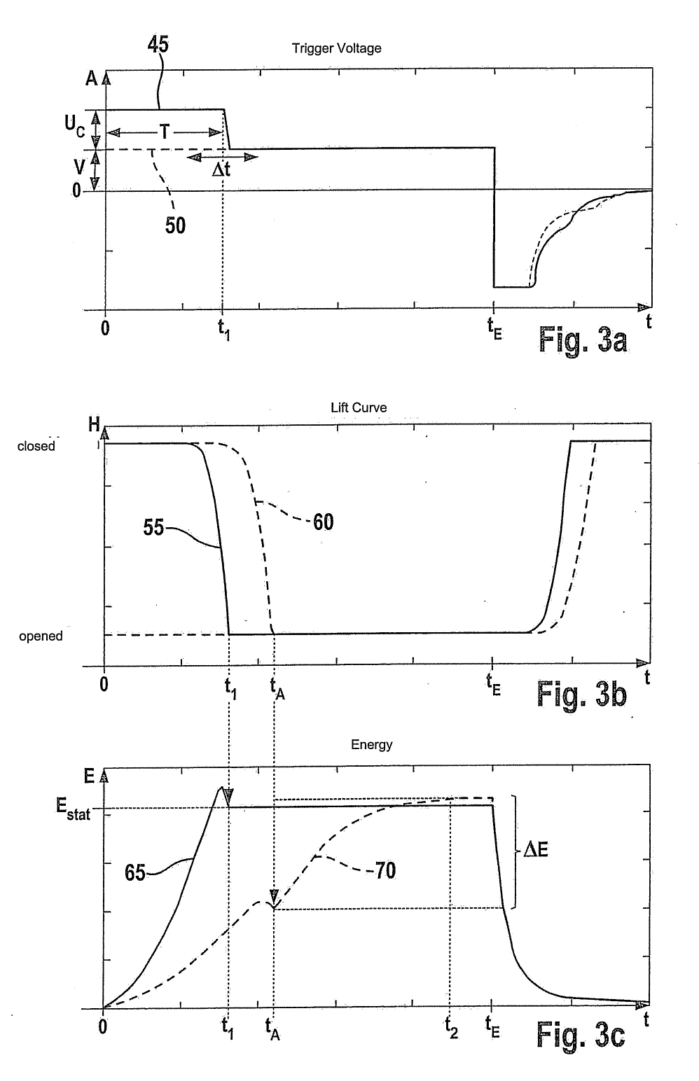

The effect of the switching of the circuit shown in FIG. 1 is explained below on the basis of FIGS. 3a, 3b, and 3c.

FIG. 3a shows the curve of trigger voltage A over time. At a point in time t=0, first controlled switch 25 is closed, second controlled switch 30 is closed, and third controlled switch 35 is opened. Thus, at point in time t=0, the sum of predefined voltage V and capacitor voltage U_{C} is applied as trigger voltage A to magnet coil 1. At a first point in time tᵢ following point in time t=0 by a predefined time T, second controlled switch 30 is opened and third controlled switch 35 is closed. In this way, trigger voltage A is reduced by capacitor voltage U_{C} at first point in time t₁, so that trigger voltage A corresponds approximately to predefined voltage V as of first point in time t₁. At a closing point in time t_{B} of the injector following first point in time t₁, first controlled switch 25 is then opened and thus trigger voltage A drops to a level approaching 0. The curve of trigger voltage A for 0≦t≦t₁ of a voltage elevated in comparison with predefined voltage V by capacitor voltage U_{C} is labeled with reference numeral 45 in FIG. 3a. On the other hand, a dashed line 50 in FIG. 3a plots the curve of trigger signal A over time approximately up to first point in time tₗ as would be obtained without the increase by capacitor voltage U_{C} according to the example embodiment of the present invention, so that the trigger voltage in this case also assumes the value of predefined voltage V for times of 0≦t≦t₁.

FIG. 3b shows the curve of lift H of the injector resulting from the curve of trigger voltage A over time according to FIG. 3a. The actuation time of the injector is shortened by the temporary increase in trigger signal A by capacitor voltage U_{C} for 0≦t≦t₁; this is also known as boostering and results in the injector transitioning from its closed state to its opened state at an earlier time, as shown in FIG. 3b, in comparison with a trigger signal A without boostering according to the dashed curve in FIG. 3a. The curve of lift H over time t in the case of trigger voltage A boostered for 0≦t≦t₁ is labeled with reference numeral 55 in FIG. 3b, whereas the curve of lift H over time at a trigger voltage A without boostering is shown with a dashed line 60 in FIG. 3c.

FIG. 3c shows the curve of energy E of the injector stored in the magnetic circuit, i.e., in magnet coil 1, resulting from the curve of trigger voltage A over time t according to FIG. 3a. The curve of energy E over time in the case of boostered trigger voltage A is labeled with reference numeral 65 in FIG. 3c, and the curve of energy E without boostering trigger voltage A is shown as a dashed line 70. In both cases, approximately the same steady-state energy Eₛₜₐₜ is achieved in the transition from the closed state to the open state of the injector. However, steady-state energy Eₛₜₐₜ is reached at an earlier time in the case of boostered trigger voltage A than in the case without boostering. Thus, with boostered trigger voltage A, steady-state energy Eₛₜₐₜ according to FIG. 3c is already reached at first point in time t₁ for example, whereas in the case without boostering of trigger voltage A, an energy level approaching Eₛₜₐₜ that is constant over time is reached only at a second point in time t₂ following first point in time t₁. This is the reason for the aforementioned shortened actuation time of the injector in the case of booster trigger voltage A.

However, FIG. 3c shows a different situation which is used for the present invention. In this situation, the injector opens in the case of boostered trigger voltage A at first point in time t₁ according to lift curve H in FIG. 3b. At this point in time according to FIG. 3c steady-state energy Eₛₜₐₜ has also been reached in the magnetic circuit of the injector. The relationship between trigger time tᵢ and fuel quantity q_{dyn} injected in trigger time t₁ is linearized in this way, thereby expanding the metering range of the injector. In the case of unboostered trigger voltage A, the injector opens at a point in time t_{A} following first point in time t₁ according to FIG. 3b. This is the actuation delay described previously, which is prevented by boostering. In conjunction with the present invention, however, it is noteworthy that according to FIG. 3c, steady-state energy level Eₛₜₐₜ has not yet been reached at opening point in time t_{A} in the case of unboostered trigger voltage A and instead this is the case only at second point in time t₂ following point in time t_{A}. Thus, there is an energy difference ΔE in comparison with curve 65 at point in time t_{A} according to curve 70 of energy over time in FIG. 3c, shown as a dashed line, and thus in comparison with the implementation using boostered trigger voltage A. Based on this energy difference ΔE until reaching steady-state level Eₛₜₐₜ, the result is a nonlinear relationship between trigger time tᵢ and fuel quantity q_{dyn} injected in trigger time tᵢ, which is prevented by the example method according to the present invention. The prerequisite for this is a suitable choice of predefined time T and thus first point in time t₁. Predefined time T should be selected within a tolerance range Δt as plotted in FIG. 3a, so that steady-state energy Eₛₜₐₜ has been reached at first point in time t₁, i.e., after predefined time T has elapsed. Steady-state energy Eₛₜₐₜ must thus be reached at first point in time t₁ when capacitor voltage U_{C} is turned off. As described, predefined time T must be selected within tolerance range Δt around first predefined point in time t₁. However, tolerance range Δt may not necessarily be symmetrical around first point in time t₁. In this case, t₁−Δt/2≦T≦t₁+Δt/2 applies according to the present invention. If predefined time T is selected so that it does not fall within the predefined tolerance range and is too short (T<tₗ−Δt/2), then the relationship between trigger time ti and the fuel quantity injected in trigger time ti is not linear. If predefined time T is selected so that it is outside of the predefined tolerance and is too long (T>t₁+Δt/2), the result is an unwanted energy reduction.

The deciding factor for the example method according to the present invention and the example device according to the present invention is thus selecting predefined time T within the predefined tolerance range with respect to achieving the steady-state energy level, i.e., steady-state energy Eₛₜₐₜ, the predefined tolerance range defining maximally the limits within which achieved energy level Eₛₜₐₜ remains constant at an approximately predefined voltage V even after a reduction in trigger voltage A by capacitor voltage U_{C}. The choice of predefined time T and thus the predefined tolerance range may be ascertained individually for each injector used, e.g., on a test bench and/or in driving trials. This choice depends, for example, on the geometry of the particular injector, the design of the closing spring of the injector used and the number of windings of magnet coil 1. Further linearization of the relationship between trigger time ti and fuel quantity q_{dyn} injected in trigger time tᵢ may be achieved, for example, with greater effort by modifying the injector, e.g., its geometry, the design of its closing spring and/or the number of windings of its magnet coil 1. For example, a range of variation of ±5% around first point in time t₁ may result as an exemplary variable for tolerance range Δt, based on first point in time t₁, under the assumption that trigger voltage A is increased from 0 to approximately V+U_{C} at point in time t=0. Linearization of the relationship between trigger time tᵢ and fuel quantity q_{dyn} injected in trigger time tᵢ with the help of boostering of trigger voltage A for predefined time T has the advantage in comparison with linearization of the aforementioned relationship, based on the described modification of the injector, that only capacitor C is necessary as an additional expense because switches 25, 30, 35 shown here may be represented as cost-neutral items in an integrated circuit. Due to the boostering of trigger voltage A, the time from reaching the stop of the valve, i.e., from reaching the opening state of the valve until reaching steady-state energy level Eₛₜₐₜ, is shortened; in the ideal case, the energy level, i.e., the energy stored by the magnetic circuit of the injector, no longer changes after reaching the stop, as depicted in FIGS. 3b and 3c, where the stop of the injector is reached at first point in time t₁, from which point forward steady-state energy level Eₛₜₐₜ that has been reached no longer changes. As described above, this then results in greater linearity of the relationship between trigger time ti and the fuel quantity injected in trigger time tᵢ because the power-down behavior and thus the closing behavior of the injector remain identical regardless of whether the power down occurs immediately after reaching the stop, i.e., immediately after reaching first point in time t₁ or only later. However, this makes a considerable difference for the case of an unboostered trigger voltage because the energy level changes from the time of reaching the stop (t_{A} in FIG. 3c) until reaching steady-state energy level Eₛₜₐₜ.

For the desired linearization of the relationship between trigger time tᵢ and fuel quantity q_{dyn} injected in trigger time tᵢ, it is also necessary for the increase in trigger voltage A to have a sufficient value for 0≦t≦t₁. The required minimum amount for the increase in trigger voltage A for boostering may be ascertained, for example, on a test bench and/or in driving trials. In a present example, capacitor C is charged to approximately predefined voltage V in unenergized phases of magnet coil 1. This is still sufficient at a minimum voltage U_{Bmin} of 4.8 V of battery 20 of the vehicle electrical system, for example. In FIG. 3a the ratio between capacitor voltage U_{C} and predefined voltage V is not drawn true to scale; in the present example, capacitor voltage U_{C} is not significantly lower than predefined voltage V.

With the temporary increase in trigger voltage A of the injector, two effects result in an increase in the metering range while simultaneously maintaining the requirement for reliable operation of the injector even at minimum voltage U_{Bmin} of the vehicle electrical system:
1. Due to the temporary increase in trigger voltage A at minimum voltage U_{Bmin} of 4.8 V of the vehicle electrical system, for example, the degree of triggering of the magnetic circuit of the injector differs less from the degree of triggering at a nominal voltage U_{Bnom} of the vehicle electrical system of 14 V, for example, than is the case with unboostered trigger voltage A. The magnetic circuit may therefore be designed to better meet dynamic requirements.
2. The temporary increase in boostering of trigger voltage A at a nominal voltage U_{Bnom} of the vehicle electrical system of 14 V, for example, during the actuation phase of the injector, increases the current rise in the injector as in the booster function described in German Patent Application No. DE 198 33 830 A1, for example. In differentiation from this in which the shortest possible actuation time of the injector is to be implemented, a different goal is pursued here. The relationship between trigger time tᵢ and fuel quantity q_{dyn} injected in trigger time tᵢ remains linear when it is certain that the energy stored in the magnetic circuit as of the power-down time or closing point in time t_{E} of the injector remains constant over time. With the example method according to the present invention and the example device according to the present invention, this may be ensured by the fact that steady-state energy level Eₛₜₐₜ at point in time t₁ of the reduction in boostering of trigger signal A has reached steady-state energy level Eₛₜₐₜ. The energy stored in the magnetic circuit thus changes only insignificantly due to the temporary increase in trigger voltage A for predefined time T after actuation of the injector at first point in time t₁ and remains generally at steady-state energy level Eₛₜₐₜ.

Variation of trigger voltage A by raising or lowering it in comparison with predefined voltage V or vehicle electrical system voltage or power supply voltage U_{B} of the injector is implementable in various ways. In addition to switching capacitor voltage U_{C} on and off by using capacitor C and controlled switches 30, 35 as illustrated in FIG. 1, a reduction in trigger voltage, such as that required at first point in time t₁, may also be achieved by series connection of a resistor between magnet coil 1 and first controlled switch 25, for example, but is out of the question in most cases because of the power loss. A low-power-loss implementation is possible by pulse-width modulation of a clocked output stage, both to lower trigger voltage A, e.g., by using a Buck converter, and to raise trigger voltage A, e.g., by using a boost converter. This approach in comparison with the circuit illustrated in FIG. 1 means a much greater circuit complexity and filter complexity because of greater problems with electromagnetic compatibility.

Trigger voltage A may thus be increased by pulse-width modulation starting from predefined voltage V by using a boost converter, also known as an upconverter.

Trigger voltage A, which is increased starting from instantaneous voltage V, may be reduced back to predefined voltage V using pulse-width modulation by the Buck converter or a downconverter after predefined time T has elapsed, regardless of how it was increased, in a conventional manner. This reduction may additionally or alternatively be achieved by the resistor connected in series with magnet coil 1 and first controlled switch 25, as described.

FIG. 2 shows a flow chart for an exemplary sequence of an example method according to the present invention. This program runs in a control unit of the gasoline engine, for example. It generates the trigger signals for control inputs X3 and X4 of the circuit shown in FIG. 1. After the program starts, the control unit receives a request for injection of fuel via the injector at a program point 100. It next branches off to a program point 105.

At program point 105, the control unit converts the received request by generating, at point in time t=0 at control input X3, a control signal which moves first control switch 25 from the opened state to the closed state. In addition, the control unit causes the closing of second controlled switch 30 and the opening of third controlled switch 35 and thus the increase in capacitor voltage U_{C} to predefined voltage V via the control signal at control input X4 at point in time t=0 in program step 105, and thus causes capacitor voltage U_{C} to increase to predefined voltage V, so that after point in time t=0, trigger voltage A=V+U_{C} is obtained on magnet coil 1. It then branches off to program point 110.

At program point 110, the control unit checks on whether predefined time T has elapsed since point in time t=0. If this is the case, then it branches off to a program point 115; otherwise it returns to program point 110.

After predefined time T has elapsed and thus within tolerance range t₁−Δt/2≦T≦t₁+Δt/2, program point 115 generates a control signal at control input X4 of second controlled switch 30 and third controlled switch 35, with which second controlled switch 30 is opened and third controlled switch 35 is closed, and thus the increase in trigger voltage A by capacitor voltage U_{C} is canceled. Next the program is exited and triggering of the injector is continued in the conventional way via control input X3, and the injector is brought to its closed state at closing point in time t_{E} by opening first controlled switch 25.

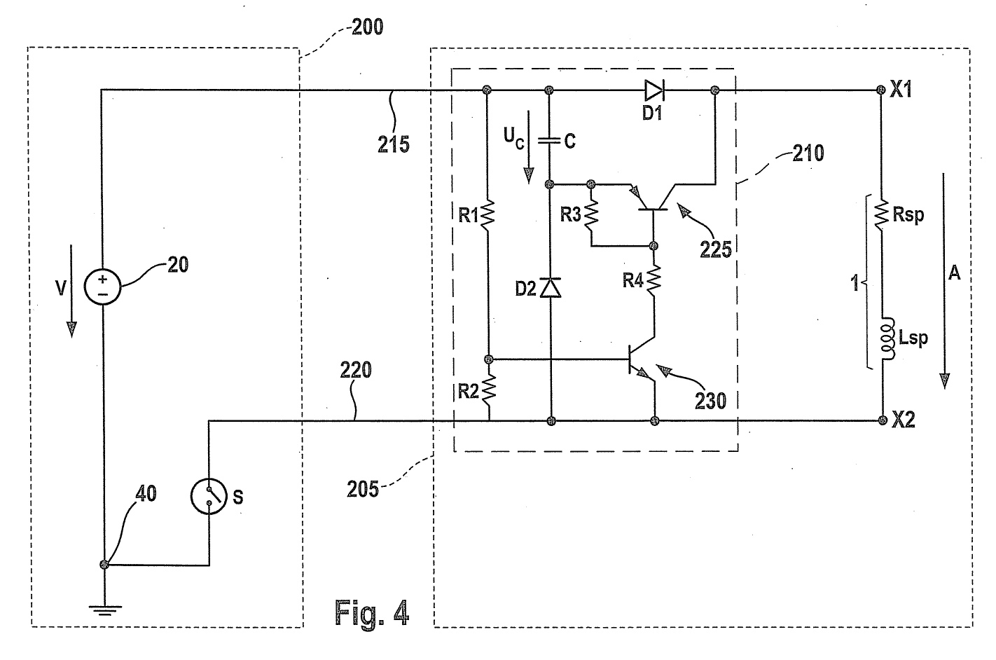

FIG. 4 also shows as an example a circuit arrangement for triggering injector 1, designed as a solenoid valve, with trigger voltage A according to a second specific example embodiment. In FIG. 4, the same reference numerals characterize the same elements as in FIG. 1.

The first specific example embodiment according to FIG. 1 is an approach for a circuit device, e.g., in a control unit, which has a minimum modification in comparison with a traditional control unit, so that the metering range of injector 1, having a linear relationship, may be expanded inexpensively. This approach is recommended specifically for the case, for example, when the injector and the control unit are operated in an interconnected system.

For the case when injector 1 is operated without such an adapted control unit or together with a traditional control unit, the circuit arrangement described according to FIG. 4 constitutes one possibility for increasing the metering range of injector 1 having a linear relationship via an autarchic electronic system, which is placed in the injector or the corresponding plug of injector 1, or in the form of an adapter in a feeder line from the control unit to injector 1. It should be pointed out that for the sake of simplicity, reference numeral 1 in FIGS. 1 and 4 represents only the magnet coil of the injector.

The circuit system described here, not including the control unit, has the following advantages:
Injector 1 having the integrated circuit system has an expanded metering range having a linear relationship also in cooperation with a traditional control unit.
No additional line is needed for signaling or for the power supply.
Injector 1 remains compatible with traditional control units.
The circuit system may be implemented as a separate module to expand the metering range of existing control unit/injector combinations with regard to the linear relationship.
The energy stored in the magnet coil of injector 1 is recovered, resulting in a reduced power loss in the control unit and an improved efficiency of the system as a whole.

FIG. 4 shows a traditional control unit 200 and an injector 205 having magnet coil 1 and integrated circuit arrangement 210. Alternatively, it is also possible, as described above, for circuit arrangement 210 to be designed as a separate module, i.e., both outside of control unit 200 and outside of injector 205, e.g., in a feeder line between control unit 200 and injector 205. Alternatively, circuit arrangement 210 may also be situated in a plug of injector 205.

First terminal X1 of magnet coil 1 of injector 205 is connected to the positive terminal (+) of a voltage source via first terminal line 215; in this example, the voltage source is designed in the form of battery 20 and forms vehicle voltage U_{B}, also corresponding in this exemplary embodiment to predefined voltage V which forms trigger voltage A. Second terminal X2 of magnet coil 1 is connected to the negative terminal (−) of battery 20, here reference potential 40, e.g., ground, via a switch S provided in control unit 200 for activating injector 205 via a second terminal line 220.

In circuit arrangement 210, the positive terminal (+) of battery 20 is connected to the anode of a first diode D1, and the cathode is connected to first terminal X1 of magnet coil 1. Furthermore, the anode of first diode D1 is connected to the second terminal of magnet coil 1 by a series connection of a first resistor R1 and a second resistor R2. First resistor R1 and second resistor R2 may be selected to be 1 kΩ each, for example. Capacitor C is connected at one end to the anode of first diode D1 and at the other end to the cathode of a second diode D2, whose anode is connected to second terminal X2 of magnet coil 1. The cathode of second diode D2 is connectable to first terminal X1 of magnet coil 1 via a fourth control switch 225. The cathode of second diode D2 is connectable to second terminal X2 of magnet coil 1 via a series connection of a third resistor R3, a fourth resistor R4 and a fifth controlled switch 230. Third resistor R3 may be selected to be 2 kΩ, for example, and fourth resistor R4 may be selected to be 1 kΩ, for example. The control input of fourth control switch 225 is formed by the terminal between third resistor R3 and fourth resistor R4. The control input of fifth controlled switch 230 is formed by the terminal between first resistor R1 and second resistor R2. Two controlled switches 225, 230 may be designed as bipolar transistors or as field-effect transistors, for example. In the present example, fourth controlled switch 225 is designed as a pnp-bipolar transistor and fifth controlled switch 230 is designed as an npn-bipolar transistor. The emitter of pnp-bipolar transistor 225 is connected to the cathode of second diode 2. The emitter of npn-bipolar transistor 230 is connected to second terminal X2 of magnet coil 1.

After the elapse of trigger time ti during which switch S is closed and magnet coil 1 is energized, control unit 200 opens switch S. The energy stored in the magnetic circuit of magnet coil 1, formed by a coil resistor Rsp and a coil inductance Lsp, drives the current through coil inductance Lsp. Capacitor C is charged via diodes D1, D2 until the magnetic energy of magnet coil 1 is dissipated. If switch S is closed for the subsequent activation of injector 205, predefined voltage V is applied to circuit arrangement 210. Therefore, npn-bipolar transistor 230 is switched through, which in turn results in pnp-bipolar transistor 225 being switched through. As a result, capacitor C, which is now charged, is in series with battery 20 and is therefore in series with predefined voltage V and causes a voltage increase on magnet coil 1 of injector 205. This voltage overshooting, as in the first exemplary embodiment, produces a shortening of the time from reaching the stop of injector 205, i.e., from reaching the opening state of injector 205 until reaching steady-state energy level Eₛₜₐₜ in the manner described in conjunction with FIGS. 3a through 3c. In the ideal case, the energy level, i.e., the energy stored by the magnetic circuit of injector 205, no longer changes after reaching the stop, as illustrated in FIGS. 3b and 3c, where the stop of the injector is reached at first point in time t₁; from this point forward, steady-state energy level Eₛₜₐₜ which has been reached no longer changes again. This then results in an increased linearity of the relationship between trigger time tᵢ and the fuel quantity injected in trigger time tᵢ as described above, because the power-down behavior and thus the closing behavior of the injector remain identical, regardless of whether the injector is powered down immediately after reaching the stop, i.e., immediately after reaching first point in time t₁, or is not powered down until later. However, this makes a considerable difference for the case of unboostered trigger voltage because the energy level changes from the point in time of reaching the stop (t_{A} in FIG. 3c ) until steady-state energy level Eₛₜₐₜ is reached.

Moreover, the statements made about the first specific embodiment according to FIG. 1 also apply similarly to the second specific embodiment according to FIG. 4. The curves in FIGS. 3a through 3c are also derived qualitatively similarly for the second specific embodiment according to FIG. 4.

In the present exemplary embodiments, the use of the injector in an intake manifold of a gasoline engine was described as an example. Alternatively, the injector may also be used in a diesel engine. Alternatively, the injector may also be used for direct injection into the combustion chamber of an internal combustion engine. Gasoline engines and diesel engines are also mentioned only as examples for the use of the injector in an internal combustion engine in this exemplary embodiment.

What is claimed is:

1. A method for triggering an injector using a trigger voltage, which is adjusted according to a predefined voltage for opening the injector, the method comprising:
increasing the trigger voltage, starting from the predefined voltage; and
reducing the trigger voltage after a predefined time, wherein the predefined time is selected in such a way that an energy stored in an energy accumulator mechanism of the injector has reached a steady-state energy level after the predefined time.

2. The method as recited in claim 1, wherein the predefined voltage is set as a function of an instantaneous power supply voltage.

3. The method as recited in claim 1, further comprising:
charging a capacitor during unenergized phases of the injector, a voltage of the capacitor being switched in series with the predefined voltage for opening the injector when the injector is activated.

4. The method as recited in claim 3, wherein the capacitor is charged to approximately the predefined voltage during the unenergized phases of the injector.

5. The method as recited in claim 1, wherein the trigger voltage is increased starting from the predefined voltage by using an upconverter.

6. The method as recited in claim 5, wherein the trigger voltage is increased by pulse-width modulation.

7. The method as recited in claim 1, wherein after the predefined time has elapsed, the trigger voltage is reduced by a downconverter.

8. The method as recited in claim 7, wherein the trigger voltage is reduced by one of by pulse-width modulation or by a series-connected resistor.

9. The method as recited in claim 1, wherein the predefined time is selected in such a way that it is within a predefined tolerance range with respect to reaching the steady-state energy level, the predefined tolerance range maximally defining limits within which an energy level achieved remains constant even after a reduction in the trigger voltage to the predefined voltage.

10. A device for triggering an injector, comprising:
a component to initially increase a trigger voltage for opening the injector starting from a predefined voltage and to reduce the trigger voltage after a predefined period of time, wherein the predefined time is selected in such a way that an energy stored in an energy accumulator mechanism of the injector has reached a steady-state energy level after the predefined time.

11. A circuit arrangement for triggering an injector, comprising:
an arrangement to first increase the trigger voltage for opening the injector starting from a predefined voltage and then reducing the trigger voltage after a predefined period of time, wherein the predefined time is selected in such a way that an energy stored in an energy accumulator mechanism of the injector has reached a steady-state energy level after the predefined time.

12. A control unit for triggering an injector, comprising:
an arrangement to adjust a trigger voltage according to a predefined voltage for opening the injector;
an arrangement to first increase the trigger voltage for opening the injector starting from the predefined voltage and to reduce the trigger voltage after a predefined period of time, wherein the predefined time is selected in such a way that an energy stored in an energy accumulator mechanism of the injector has reached a steady-state energy level after the predefined time.
